(19) United States
(12) Patent Application Publication
(10) Pub. No.: US 2016/0347991 A1
(43) Pub. Date: Dec. 1, 2016

(54) SELF-BREAKING FRACTURING FLUIDS AND METHODS FOR TREATING HYDROCARBON-BEARING FORMATIONS

(71) Applicant: Richard Wheeler, Crosby, TX (US)

(72) Inventor: Richard Wheeler, Crosby, TX (US)

(73) Assignee: Baker Hughes Incorporated, Houston, TX (US)

(21) Appl. No.: 15/153,876

(22) Filed: May 13, 2016

Related U.S. Application Data
(60) Provisional application No. 62/169,182, filed on Jun. 1, 2015.

(51) Int. Cl. C09K 8/68; E21B 43/267; E21B 43/26; E21B 43/25; C09K 8/80; C09K 8/88

(52) U.S. Cl. CPC C09K 8/68; C09K 8/80; C09K 8/88; E21B 43/26; E21B 43/25; E21B 43/267

(57) ABSTRACT

Disclosed herein is a fracturing fluid including a carrier fluid and a viscosity-increasing self-breaking synthetic polymer soluble in the carrier fluid. A method for treating a hydrocarbon-bearing formation is also disclosed.

### CROSS REFERENCE TO RELATED APPLICATIONS

This application claims the benefit of an earlier filing date from U.S. Provisional Application Ser. No. 62/169,182 filed Jun. 1, 2015, the entire disclosure of which is incorporated herein by reference.

### BACKGROUND

Hydraulic fracturing is a process by which cracks or fractures in a subterranean zone are created by pumping a fracturing fluid at a pressure that exceeds the parting pressure of the rock. The fracturing fluid creates or enlarges fractures in the subterranean zone so that a proppant material suspended in the fracturing fluid may be pumped into the created fracture. The created fracture continues to grow as more fluid and proppant are introduced into the formation. The proppants remain in the fractures in the form of a permeable “pack” that serves to hold or “prop” the fractures open. After placement of the proppant materials, the fracturing fluid can be “broken” and recovered by adding a breaking agent or using a delayed breaker system already present in the fracturing fluid to reduce the viscosity of the fracturing fluid. Reduction in fluid viscosity along with fluid leak-off from the created fracture into permeable areas of the formation allows for the fracture to close on the proppants following the treatment. By maintaining the fracture open, the proppants provide a highly conductive pathway for hydrocarbons and/or other formation fluids to flow into the borehole.

Slickwater fracturing is a type of treatment used in the stimulation of unconventional formations. During the slickwater hydraulic fracturing process, the pumping rate is generally very high to facilitate the placement of proppants into the formation in conjunction with the use of the low viscosity fluid. At these high fluid velocities, the proppants in the fracturing fluids can be very abrasive, leading to reduced service life for fracturing equipment. In addition, friction between various components of the fracturing equipment can produce wear of the equipment. It is therefore desirable to reduce the wear on the equipment during fracturing.

A number of friction-reducing materials are known. For example, guar, a naturally occurring material, is often used to increase the viscosity in fracturing fluids to reduce the amount of wear, but large amounts of guar are used and the demand for guar has increased greatly in recent years. It is therefore desirable to provide an alternative to guar-containing fracturing fluids, which solves one or more of the above problems associated with the use of guar.

### BRIEF DESCRIPTION

A fracturing fluid for a subterranean formation comprises an aqueous carrier fluid, and a viscosity-increasing synthetic polymer soluble in the carrier fluid, wherein the polymer is self-breaking.

A method for treating a hydrocarbon-bearing formation comprises introducing the fracturing fluid into a borehole in a hydrocarbon-bearing formation, maintaining the fracturing fluid in the borehole for a period of time effective for self-breaking of the fracturing fluid, and recovering the broken fracturing fluid.

The above described and other features are exemplified by the following Figures, Detailed Description, Examples, and Claims.

### BRIEF DESCRIPTION OF THE DRAWINGS

The following Figures are exemplary embodiments.

FIG. 1 shows the viscosity profile (centipoise, cP) at a shear rate of 511 s⁻¹ of a 20 pound-per-thousand-gallon (pptg) solution of synthetic polymers A and B in water over time at ambient temperature.

FIG. 2 shows the viscosity profile (cP) at a shear rate of 511 s⁻¹ of a 20 pptg solution of synthetic polymers A and B in water over time at elevated temperature.

### DETAILED DESCRIPTION

Described herein is a self-breaking fracturing fluid that includes a self-breaking synthetic polymer and an aqueous carrier fluid. The synthetic polymer initially increases the viscosity of the fracturing fluid, and thus can be added to reduce proppant settling or to reduce fluid flow friction. In an advantageous feature, the synthetic polymer is “self-breaking,” i.e., does not require a breaking additive in order to break the fracturing fluid. The breaking occurs over time, and optionally with a change in condition of the fracturing fluid as described in further detail below. Advantageously the fracturing fluid and the polymer can be selected so as to provide the desired maximum viscosity and breaking time. In another unexpected feature, temperature can be used to promote self-breaking of the polymer and lower the viscosity of the fluid where the low viscosity is retained upon cooling. These features allow more precise placement of the fracturing fluid and ready removal.

The viscosity-increasing polymer used in the self-breaking fracturing fluid has as number of advantageous features. The polymer is a synthetic, or man-made, polymer. It is thus not subject to availability fluctuations as is the case with some natural polymers.

The viscosity-increasing synthetic polymer is further highly soluble in aqueous carrier fluids, for example an aqueous medium such as water or slickwater. Rapid solubility allows a rapid increase in the viscosity of the fracturing fluid upon mixing with the polymer. The viscosity-increasing polymer accordingly comprises a polymer backbone comprising units derived by polymerization of (meth)acrylamide, N—(C₁-C₈ alkyl)acrylamide N,N-di(C₁-C₈ alkyl)acrylamide, vinyl alcohol, allyl alcohol, vinyl acetate, acrylonitrile, (meth)acrylic acid, ethacrylic acid, α-chloroacrylic acid, β-cyanoacrylic acid, β-methylacrylic acid (crotonic acid), α-phenylacrylic acid, β-acryloyloxypropionic acid, maleic acid, maleic anhydride, fumaric acid, itaconic acid, sorbic acid, α-chlorosorbic acid, 2′-methylisocrotonic acid, 2-acrylamido-2-methylpropane sulphonic acid, allyl sulphonic acid, vinyl sulphonic acid, allyl phosphonic acid, vinyl phosphonic acid, (C₁₋₃ alkyl) (meth)acrylate, (hydroxy-C₁₋₆ alkyl) (meth)acrylate, (dihydroxy-C₁₋₆ alkyl) (meth)acrylate, (trihydroxy-C₁₋₆ alkyl) (meth)acrylate, diallyl dimethyl ammonium chloride, N,N-di-(C₁₋₆ alkyl)amino (C₁₋₆ alkyl) (meth)acrylate, 2-ethyl-2-oxazoline, (meth)acryloxy(C₁₋₆ alkyl) tri(C₁₋₆ alkyl(ammonium halide), 2-vinyl-1-methylpyridinium halide, 2-vinylpyridine N-oxide, 2-vinylpyridine, or a combination comprising at least one of the foregoing.

Specific examples of the foregoing include acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butyl acrylamide, N-vinylformamide, N-vinylacetamide, acrylonitrile, methacrylonitrile, vinyl alcohol, a combination of acrylamide and acrylic acid, diallyl dimethyl ammonium chloride, 1-glycerol (meth)acrylate, 2-dimethylaminoethyl (meth)acrylate), 2-hydroxyethyl methacrylate, a combination of 2-hydroxyethyl methacrylate and methacrylic acid, 2-hydroxypropyl methacrylate, 2-methacryloxyethyl trimethyl ammonium bromide, 2-vinylpyridine, and 3-chloro-2-hydroxypropyl-2-methacryloxyethyl dimethyl ammonium chloride.

Units that do not impart water solubility to the polymer can also be present in the polymer, provided that the type and amount of such units do not significantly adversely affect the intended function of the polymer, in particular its water solubility. Non-limiting examples of such hydrophobic units include (C₃₋₁₆ alkyl) (meth)acrylate, (meth)acrylonitrile, styrene, alpha-methyl styrene, ethylene, isoprene, butadiene, and the like. In an embodiment, the polymers comprise less than 25 mole % of such units, or are devoid of such units.

When the viscosity-increasing synthetic polymer comprises hydrophobic units, the amount and type of units are selected to provide the polymer with a solubility parameter that is proximate to that of the carrier fluid so that the polymer can rapidly dissolve in the carrier fluid. The selection of units can be determined, in part, using the Hildebrand solubility parameter of the chemical constituents, a numerical parameter that indicates the relative solvency behavior in a specific solvent (here, the carrier fluid). By tailoring the polymer structure (e.g., by combining appropriate amounts of hydrophilic units with hydrophobic units) the solubility parameter of the polymer can be tailored to be proximate to that of a particular carrier fluid. The solubility parameter of the polymer can be calculated based on the relative weight fractions of each constituent of the polymer according to equation (1):

δ_{polymer}=w₁δ₁+w₂δ₂ (1)

where δ_{polymer} is the Hildebrand solubility parameter of the copolymer, δ₁ is the solubility parameter the hydrophilic polymer units, w₁ is the weight fraction of the hydrophilic polymer units, δ₂ is the solubility parameter of the hydrophobic polymer units, and w₂ is the weight fraction of the hydrophobic polymer units. In an embodiment, the calculated solubility parameter of the polymer is within about 25% of the solubility parameter of the carrier fluid, or within about 15% of the solubility parameter of the carrier fluid.

The viscosity-increasing synthetic polymer can be a homopolymer or copolymer, including a block copolymer, an alternating block copolymer, a random copolymer, a random block copolymer, a graft copolymer, or a star block copolymer. It can further be ionomeric. The polymer can be linear, branched, or crosslinked.

A combination of two or more viscosity-increasing polymers can be used. For example, the fracturing fluid can comprise a first viscosity-increasing synthetic polymer as described above and a second viscosity-increasing polymer that are blended together or that are copolymerized together. The copolymerization may involve covalent bonding and/or ionic bonding. The second polymer can be synthetic or natural, and hydrophobic or hydrophilic, provided that the resulting polymer composition is soluble in the carrier fluid.

Examples of synthetic hydrophobic polymers include polyacetals, polyolefins, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalimides, polyanhydrides, polyvinyl ethers, polyvinyl thioethers, polyvinyl ketones, polyvinyl halides, polyvinyl nitriles, polyvinyl esters, polysulfonates, polysulfides, polythioesters, polysulfonamides, polyureas, polyphosphazenes, polysilazanes, polyethylene terephthalate, polybutylene terephthalate, polyurethane, polytetrafluoroethylene, polychlorotrifluoroethylene, polyvinylidene fluoride, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, and polysiloxanes. A combination comprising at least one of the foregoing can be used. In an embodiment, the self-breaking polymer compositions are devoid of any of the foregoing synthetic hydrophobic polymers, except where such polymers are used for another purpose, such as a coating for a proppant.

A “naturally occurring” polymer is one that is derived from a living being including an animal, a plant, and a microorganism. Examples of naturally occurring polymers can include polysaccharides, derivatives of polysaccharides (e.g., hydroxyethyl guar (HEG), carboxymethyl guar (CMG), carboxyethyl guar (CEG), carboxymethyl hydroxypropyl guar (CMHPG)), cellulose, cellulose derivatives (e.g., hydroxyethylcellulose (HEC), hydroxypropylcellulose (HPC), carboxymethylcellulose (CMC), carboxyethylcellulose (CEC), carboxymethyl hydroxyethyl cellulose (CMHEC), carboxymethyl hydroxypropyl cellulose (CMHPC)), karaya, locust bean, pectin, tragacanth, acacia, carrageenan, alginates (e.g., salts of alginate, propylene glycol alginate, and the like), agar, gellan, xanthan, scleroglucan, or a combination comprising at least one of the foregoing. In some embodiments, the self-breaking polymer compositions are devoid of a natural polymer, for example devoid of guar.

Where a combination of hydrophilic and hydrophobic polymers is used, the calculated solubility parameter of the polymer blend is within about 25% of the solubility parameter of the carrier fluid, or within about 15% of the solubility parameter of the carrier fluid. The solubility parameter of the polymer blend can be calculated based on Hildebrand solubility parameters as is known in the art.

The viscosity-increasing polymer can optionally be crosslinkable and is sometimes crosslinked before or during a fracturing operation. For example, the polymer can be co-polymerized with crosslinkable units and the crosslinkable units are crosslinked during a fracturing operation. Crosslinking the polymer can further increase the viscosity of the resulting fracturing fluid, trap proppant materials, and prevent settling of proppant materials.

Non-limiting examples of crosslinking agents include crosslinking agents comprising a metal such as boron, titanium, zirconium, and/or aluminum complexes. Crosslinking increases the molecular weight and is particularly desirable in high-temperature wells to avoid degradation, and other undesirable effects of high-temperature applications. The crosslinking agent, when used, can be present in the fracturing fluid in an amount of about 0.01 percent by weight (wt %) to about 2.0 wt %, specifically about 0.02 wt % to about 1.0 wt %, based on the total weight of the fracturing fluid.

As stated above, the synthetic polymer is self-breaking in the fracturing fluid with nothing more than the passage of time. The polymer comprises a labile functionality that results in a reduction in the viscosity of the fracturing fluid with the passage of time. Without being bound by theory, it is believed that activation of the labile group facilitates or results in degradation of viscosity-enhancing synthetic polymer. Activation can be, for example by oxidation, reduction, photo-degradation, thermal degradation, hydrolysis, chemical degradation, or microbial degradation, depending on the labile functionality. The rate at which the degradation of the polymer occurs can be depend on, for example, type of labile group, composition, sequence, length, molecular geometry, molecular weight, stereochemistry, hydrophilicity, hydrophobicity, additives and environmental conditions such as temperature, presence of moisture, oxygen, microorganisms, enzymes, and pH of the fracturing fluid.

The labile functionality can be a water soluble group. Labile groups can include ester groups, amide groups, carbonate groups, azo groups, disulfide groups, orthoester groups, acetal groups, etherester groups, ether groups, silyl groups, phosphazine groups, urethane groups, esteramide groups, etheramide groups, anhydride groups, and any derivative or combination thereof. The labile group can be derived from oligomeric or short chain molecules that include poly(anhydrides), poly(orthoesters), poly(lactic acids), poly(glycolic acids), poly(caprolactones), poly(hydroxybutyrates), polyphosphazenes, poly(carbonates), polyacetals, polyetheresters, polyesteramides, polycyanoacrylates, polyurethanes, polyacrylates, or the like, or a combination comprising at least one of the foregoing oligomeric or short chain molecules. The labile group can be derived from a hydrophilic polymeric block comprising a poly(alkylene glycol), a poly(alcohol) made by the hydrolysis of poly(vinyl acetate), a poly(vinyl pyrrolidone), a polysaccharide, a chitin, a chitosan, a protein, a poly(amino acid), a poly(alkylene oxide), a poly(amide), a poly(acid), a polyol, and any derivative, copolymer, or combination comprising at least one of the foregoing.

The viscosity-increasing polymer can be prepared by any of the methods well known to those skilled in the art. For example, the polymer can be manufactured by emulsion (or inverse emulsion) polymerization to obtain high molecular weights. In emulsion or inverse emulsion polymerization, the polymer is suspended in a fluid. The fluid in which the polymer is suspended can be water. The manufacturing and use of the polymer in emulsion form makes possible use as a liquid additive, simplifying its use in the fracturing fluid. In some embodiments, the polymer is isolated as a dry powder that can be dissolved in a carrier fluid to form the fracturing fluid.

The viscosity-increasing synthetic polymer can have a number average molecular weight (Mn) of about 2,000,000 to about 20,000,000 grams per mole (g/mol), specifically about 10,000,000 to about 18,000,000 g/mol.

In an exemplary embodiment, the viscosity-increasing synthetic polymer used in the fracturing fluid is a polyacrylamide. A commercially available synthetic polymer having labile groups and comprising polyacrylamide is MaxPerm-20A® available from Baker Hughes, Inc.

The viscosity-increasing polymer can be present in the fracturing fluid in an amount of about 0.01 to about 20 percent by weight (wt %), specifically about 0.05 to about 10 wt %, and more specifically about 0.1 to about 5 wt %, based on the total weight of the fracturing fluid.

The fracturing fluid further comprises an aqueous carrier fluid generally suitable for use in hydrocarbon (i.e., oil and gas) producing wells, such as slickwater. The carrier fluid solvates the polymer and transports the proppant materials downhole to the hydrocarbon bearing formation. Water is generally a major component by total weight of the carrier fluid. The aqueous carrier fluid can be fresh water, brine (including seawater), an aqueous acid, for example a mineral acid or an organic acid, an aqueous base, or a combination comprising at least one of the foregoing. The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from the ground. Produced water can also be referred to as reservoir brine and contain components including barium, strontium, and heavy metals. In addition to naturally occurring brines (e.g., seawater and produced water), completion brine can be synthesized from fresh water by addition of various salts for example, NaCl, KCl, NaBr, MgCl₂, CaCl₂, CaBr₂, ZnBr₂, NH₄Cl, sodium formate, cesium formate, and combinations comprising at least one of the foregoing. The salt can be present in the brine in an amount of about 0.5 to about 50 weight percent (wt. %), specifically about 1 to about 40 wt. %, and more specifically about 1 to about 25 wt. %, based on the weight of the fracturing fluid. The carrier fluid can be recycled fracturing fluid water or its residue. In an embodiment the aqueous carrier fluid is slickwater, having, for example, a viscosity of 1 to 3 centipoise at 20° C.

The fracturing fluid can be a slurry, or an emulsion. As used herein, the term “emulsion” refers to a mixture of two or more normally immiscible liquids forming a two-phase colloidal system wherein a liquid dispersed phase is dispersed in a liquid continuous phase. For example, the fracturing fluid can be an oil-in-water emulsion. As used herein, the term “slurry” refers to a thick suspension of solids in a liquid.

The aqueous carrier fluid can be an aqueous mineral acid such as hydrochloric acid, nitric acid, phosphoric acid, sulfuric acid, boric acid, hydrofluoric acid, hydrobromic acid, perchloric acid, or a combination comprising at least one of the foregoing. The fluid can be an aqueous organic acid that includes a carboxylic acid, sulfonic acid, or a combination comprising at least one of the foregoing. Exemplary carboxylic acids include formic acid, acetic acid, chloroacetic acid, dichloroacetic acid, trichloroacetic acid, trifluoroacetic acid, propionic acid, butyric acid, oxalic acid, benzoic acid, phthalic acid (including ortho-, meta- and para-isomers), and the like. Exemplary sulfonic acids include a C₁₋₂₀ alkyl sulfonic acid, wherein the alkyl group can be branched or unbranched and can be substituted or unsubstituted, or a C₃₋₂₀ aryl sulfonic acid wherein the aryl group can be monocyclic or polycyclic, and optionally comprises 1 to 3 heteroatoms (e.g., N, S, or P). Alkyl sulfonic acids can include, for example, methane sulfonic acid. Aryl sulfonic acids include, for example, benzene sulfonic acid or toluene sulfonic acid. In some embodiments, the aryl group can be C₁₋₂₀ alkyl-substituted, i.e., is an alkylarylene group, or is attached to the sulfonic acid moiety via a C₁₋₂₀ alkylene group (i.e., an arylalkylene group), wherein the alkyl or alkylene can be substituted or unsubstituted.

The fracturing fluid can comprise the carrier fluid in an amount of about 90 to about 99.95 wt %, based upon the total weight of the fracturing fluid. For example, the fracturing fluid can comprise the carrier fluid in an amount of about 95 to about 99.9 wt %, specifically about 99 to about 99.5 wt %, based on the total weight of the fracturing fluid.

A proppant can optionally further be included in the fracturing fluid, in an amount of about 0.01 to about 60 wt %, or about 0.1 to about 40 wt %, or about 0.1 to about 12 wt %, based on the total weight of the fracturing fluid. Suitable proppants are known in the art and can be a relatively lightweight or substantially neutrally buoyant particulate material or a mixture comprising at least one of the foregoing. Such proppants can be chipped, ground, crushed, or otherwise processed. By “relatively lightweight” it is meant that the proppant has an apparent specific gravity (ASG) that is substantially less than a conventional proppant employed in hydraulic fracturing operations, for example, sand or having an ASG similar to these materials. Especially preferred are those proppants having an ASG less than or equal to 3.25. Even more preferred are ultra-lightweight proppants having an ASG less than or equal to 2.40, more preferably less than or equal to 2.0, even more preferably less than or equal to 1.75, most preferably less than or equal to 1.25 and often less than or equal to 1.05.

The proppant can comprise sand, glass beads, walnut hulls, metal shot, resin-coated sands, intermediate strength ceramics, sintered bauxite, resin-coated ceramic proppants, plastic beads, polystyrene beads, thermoplastic particulates, thermoplastic resins, thermoplastic composites, thermoplastic aggregates containing a binder, synthetic organic particles including nylon pellets and ceramics, ground or crushed shells of nuts, resin-coated ground or crushed shells of nuts, ground or crushed seed shells, resin-coated ground or crushed seed shells, processed wood materials, porous particulate materials, and combinations comprising at least one of the foregoing. Ground or crushed shells of nuts can comprise shells of pecan, almond, ivory nut, brazil nut, macademia nut, or combinations comprising at least one of the foregoing. Ground or crushed seed shells can include fruit pits, and can comprise seeds of fruits including plum, peach, cherry, apricot, and combinations comprising at least one of the foregoing. Ground or crushed seed shells can further comprise seed shells of other plants including maize, for example corn cobs and corn kernels. Processed wood materials can comprise those derived from woods including oak, hickory, walnut, poplar, and mahogany, and includes such woods that have been processed by any means that is generally known including grinding, chipping, or other forms of particulization. A porous particulate material can be any porous ceramic or porous organic polymeric material, and can be natural or synthetic. The porous particulate material can further be treated with a coating material, a penetrating material, or modified by glazing.

The proppant can be coated, for example, with a resin or polymer. Individual proppant particles can have a coating applied thereto. If the proppant particles are compressed during or subsequent to, for example, fracturing, at a pressure great enough to produce fine particles therefrom, the fine particles remain consolidated within the coating so they are not released into the formation. It is contemplated that fine particles decrease conduction of hydrocarbons (or other fluid) through fractures or pores in the fractures and are avoided by coating the proppant. Coatings for the proppant can include cured, partially cured, or uncured coatings of, for example, a thermosetting or thermoplastic polymer. Curing the coating on the proppant can occur before or after disposal of the hydraulic fracturing fluid downhole, for example.

The coating can be an organic compound such as epoxy, phenolic, polyurethane, polycarbodiimide, polyamide, polyamide imide, furan resins, or a combination comprising at least one of the foregoing; a thermoplastic such as polyethylene, acrylonitrile-butadiene styrene, polystyrene, polyvinyl chloride, fluoropolymers, polysulfide, polypropylene, styrene acrylonitrile, nylon, and phenylene oxide; or a thermoset resin such as epoxy, phenolic (a true thermosetting resin such as resole or a thermoplastic resin that is rendered thermosetting by a hardening agent), polyester, polyurethane, and epoxy-modified phenolic resin. The coating can be a combination comprising at least one of the foregoing. A curing agent for the thermoset resin coating can be amines and their derivatives, carboxylic acid terminated polyesters, anhydrides, phenol-formaldehyde resins, amino-formaldehyde resins, phenol, bisphenol A and cresol novolacs, phenolic-terminated epoxy resins, polysulfides, polymercaptans, and catalytic curing agents such as tertiary amines, Lewis acids, Lewis bases, or a combination comprising at least one of the foregoing.

The proppant can include a crosslinked coating. The crosslinked coating can provide crush strength, or resistance, for the proppant and prevent agglomeration of the proppant even under high pressure and temperature conditions. The proppant can have a curable coating, which cures subsurface, for example, downhole or in a fracture. The curable coating can cure under the high pressure and temperature conditions in the subsurface reservoir. Thus, the proppant having the curable coating can be used for high pressure and temperature conditions.

The coating can be disposed on the proppant by mixing in a vessel, for example, a reactor. Individual components including the proppant and resin materials (e.g., reactive monomers used to form, e.g., an epoxy or polyamide coating) can be combined in the vessel to form a reaction mixture and agitated to mix the components. Further, the reaction mixture can be heated at a temperature or at a pressure commensurate with forming the coating. The coating can be disposed on the particle via spraying for example by contacting the proppant with a spray of the coating material. The coated proppant can be heated to induce crosslinking of the coating.

The fracturing fluid can optionally further comprise other additives as are generally known and used in fracturing fluids, for example a scale inhibitor, a tracer, a buffering agent, a lubricant, a non-emulsifier, a clay stabilizer, a surfactant, a biocide, an acid, a corrosion inhibitor, a pH-adjusting agent, an emulsifier, a fluid loss control agent, a mineral, oil, alcohol, or a combination comprising at least one of the foregoing additives. Each additive can be present in the generally used amount, for example, 0.005 to 10 wt %, based on the total weight of the fracturing fluid.

One advantage of the fracturing fluids is that no breaking agent is required, although a breaking agent can be added. Breaking agents “break” or diminish the viscosity of the fracturing fluid so that the fracturing fluid is more easily recovered from the formation during cleanup, for example, using flowback. Breaking agents can include oxidizers, enzymes, or acids. Breaking agents can reduce the polymer molecular weight by the action of an acid, an oxidizer, an enzyme, or some combination of these on the polymer. Breaking agents can include persulfates, ammonium persulfate, sodium persulfate, potassium persulfate, bromates such as sodium bromate and potassium bromate, periodates, peroxides such as calcium peroxide, hydrogen peroxide, bleach such as sodium perchlorate and organic percarboxylic acids or sodium salts, organic materials such as enzymes and lactose, chlorites, or a combination comprising at least one of the foregoing breaking agents. Breaking agents can be introduced into the fracturing fluid “as is” or in an encapsulated form to be activated by a variety of mechanisms including crushing by formation closure or dissolution by formation fluids. In some embodiments, it is preferred that the fracturing fluid has no breaking agent.

The fracturing fluid can be manufactured by various methods according to general techniques, which are known. For example, a method for manufacturing the fracturing fluid can comprise dissolving the viscosity-increasing synthetic polymer into the carrier fluid in an amount effective to increase the viscosity of the carrier fluid to the desired level. Additives including proppant, surfactants, and the like, can be present in the carrier fluid either prior to the addition of the polymer or can be added to the carrier fluid after the addition of the polymer.

Before dissolving the viscosity-increasing synthetic polymer, the carrier fluid can have a viscosity of ≦3 centipoise, measured at 20° C. Immediately after a first period of time (i.e., immediately after dissolution, which is the first hydration of the polymer), the fracturing fluid has a first viscosity. The first viscosity can be determined, for example, 1 to 5 minutes after combining the carrier fluid and the viscosity-increasing synthetic polymer. The first viscosity after hydration of the polymer is increased relative to the carrier fluid. As is known in the art, the first viscosity will depend on whether the fracturing fluid is a slickwater fracturing fluid, a gel fluid, or a crosslinked gel fluid.

The first viscosity can accordingly be in the range of about 1 to about 60 centipoise at 20° C., preferably about 2 to about 50 centipoise at 20° C., more preferably about 3 to about 60 centipoise at 20° C., again depending on the type of fluid. The first viscosity of a slickwater can be in the range of about 1 to about 15 centipoise at 20° C., preferably about 1 to about 10 centipoise at 20° C., more preferably about 1 to about 5 centipoise at 20° C. The first viscosity of a linear gel fluid can be in the range of about 3 to about 60 centipoise at 20° C., preferably about 5 to about 50 centipoise at 20° C., more preferably about 10 to about 40 centipoise at 20° C. The first viscosity of a crosslinked gel fluid (before crosslinking) can be in the range of about 3 to about 60 centipoise at 20° C., preferably about 5 to about 50 centipoise at 20° C., more preferably about 10 to about 40 centipoise at 20° C. In some embodiments, the first viscosity can be about 1 to about 20 centipoise at 20° C., preferably about 2 to about 15 centipoise at 20° C., more preferably about 3 to about 12 centipoise at 20° C.

After a second period of time, subsequent to the first period of time, the viscosity of the fracturing fluid attains a maximum, referred to herein as a second viscosity. The second viscosity is higher than the first viscosity, and will also depend on the type of fracturing fluid, and can generally be in the range of about 5 to about 60 centipoise at 20° C., preferably about 5 to about 40 centipoise at 20° C., more preferably about 5 to about 30 centipoise at 20° C. The second viscosity of a slickwater can be in the range of about 1 to about 15 centipoise at 20° C., preferably about 1 to about 10 centipoise at 20° C., more preferably about 1 to about 5 centipoise at 20° C. The second viscosity of a linear gel fluid can be in the range of about 3 to about 60 centipoise at 20° C., preferably about 5 to about 50 centipoise at 20° C., more preferably about 10 to about 40 centipoise at 20° C. The second viscosity of a crosslinked gel fluid can be in the range of about 3 to about 60 centipoise at 20° C., preferably about 5 to about 50 centipoise at 20° C., more preferably about 10 to about 40 centipoise at 20° C. In some embodiments, the maximum second viscosity at 20° C. is about 5% to about 900% higher than the first viscosity at 20° C., preferably about 15% to about 500% higher than the first viscosity at 20° C., more preferably about 20% to about 300% than the first viscosity at 20° C.

The type and amount of the viscosity-increasing synthetic polymer and the carrier fluid is selected so as to attain the maximum second viscosity at the desired time in the subterranean formation. For example, the maximum second viscosity can be achieved in about 5 to about 60 minutes following introduction of the polymer to the carrier fluid, preferably about 10 to about 30 minutes. In some embodiments the viscosity of the carrier fluid can be increased by about 40% to about 900% in about 5 to about 20 minutes following introduction of the polymer to the carrier fluid, preferably the viscosity of the carrier fluid can increased by about 15% to about 500% in about 5 to about 20 minutes following introduction of the polymer to the carrier fluid, more preferably the viscosity of the carrier fluid can be increased by about 50% to about 750% in about 10 to about 15 minutes following introduction of the polymer to the carrier fluid.

After a third period of time subsequent to the second period of time, the viscosity of the fracturing fluid attains a third viscosity, by self-breaking of the fluid. The third viscosity is lower than the maximum second viscosity and results from the breaking of the fracturing fluid. The third viscosity can be measured, for example, at five minutes to three hours after the initial mixing, for example, one hour after the initial mixing, and can vary depending on the type of fluid, reservoir temperature, fluid pH, and other chemicals that may be present in the fracturing fluid, and the like. For example, the third viscosity can generally be about 1 to about 20 centipoise at 20° C., preferably about 1 to about 15 centipoise at 20° C., more preferably about 1 to about 10 centipoise at 20° C. The third viscosity of a slickwater can be in the range of about 1 to about 10 centipoise at 20° C., preferably about 1 to about 7 centipoise at 20° C., more preferably about 1 to about 3 centipoise at 20° C. The third viscosity of a linear gel fluid can be in the range of about 1 to about 20 centipoise at 20° C., preferably about 1 to about 15 centipoise at 20° C., more preferably about 1 to about 10 centipoise at 20° C. The third viscosity of a crosslinked gel fluid can be in the range of about 1 to about 50 centipoise at 20° C., or about 1 to about 30 centipoise at 20° C., or about 1 to about 15 centipoise at 20° C. In an embodiment, the third viscosity at 20° C. is about 10% to about 80% lower than the maximum second viscosity at 20° C., or about 15% to about 70% lower than the maximum second viscosity at 20° C., or about 20% to about 60% than the first viscosity at 20° C.

In some embodiments, subjecting the fracturing fluid to a breaking condition, in addition to the passage of time, can lower the third viscosity even further. Without being bound by theory, it is believed that the breaking condition enhances the degradation of the viscosity-increasing synthetic polymer. Suitable breaking conditions will depend on the type and amount of the viscosity-increasing synthetic polymer, the type of carrier, the type of additives, downhole conditions, and like considerations. Examples of breaking conditions include a change in temperature, pH, water content of the fracturing fluid, osmolality of the fracturing fluid, salt concentration of the fracturing fluid, additive concentration of the fracturing fluid (e.g., presence and concentration of oxidizing agent), presence of biological agents (e.g., enzymes), or a combination comprising at least one of the foregoing conditions.

The change in condition (the breaking condition, for example temperature or the presence of an oxidizing agent) can be applied at any time during the first period, the second period, the third period, or any combination thereof. When subjected to a breaking condition, the third viscosity can be, for example 1 to 5 cP at 20° C. In an embodiment, the third viscosity is about 20% to about 95% lower than the maximum second viscosity of the fluid. One such breaking condition is temperature. In an embodiment, the third viscosity of the fracturing fluid at 122° F. (50° C.) is about 20% to about 95% lower than the maximum second viscosity at 122° F. (50° C.), and is 1 to 5 cP at 122° C.

Again, the above first, second, and third viscosities are only exemplary, and can vary depending on the particular type of fracturing fluid employed, for example whether the fracturing fluid is a slickwater, a fluid containing a linear gel, or a fluid containing a crosslinked polymer as described above, and the particular conditions of each fracturing operation. In an advantageous feature, selection of the appropriate polymer and other fluid components allows selection of the maximum viscosity, the time to maximum viscosity, and the time to breaking. For example, selection of a polymer that provides a linear gel will lead to a higher viscosity and selection of a polymer that leads to a crosslinked gel provides the highest viscosity. The breaking period for a crosslinked gel can also be longer than for other polymers. Alternatively, the time to breaking can be adjusted by adjusting the breaking condition, or use of an encapsulated breaking agent.

Also disclosed is a method of treating a hydrocarbon-bearing formation having a borehole. As used herein, the term “treating” or “treatment” refers to any hydrocarbon-bearing formation operation that uses a fluid in conjunction with a desired function or purpose. The term “treatment” or “treating” does not imply any particular action by the fluid or any particular constituent thereof. Further as used herein a “borehole” is any type of well, such as a producing well, a non-producing well, an experimental well, an exploratory well, a well for storage or sequestration, and the like. Boreholes include any type of downhole fracture, and may be vertical, horizontal, some angle between vertical and horizontal, diverted or non-diverted, and combinations thereof, for example a vertical borehole with a non-vertical component. In a method for treating a hydrocarbon-bearing formation, the self-breaking fracturing fluid is introduced (e.g., pumped) into the borehole.

In an embodiment, the fracturing fluid is formulated, and immediately introduced into the borehole, in particular a downhole fracture in the hydrocarbon-bearing formation. Rapid hydration of the viscosity-increasing synthetic polymer by the carrier fluid increases the viscosity of the fracturing fluid just before or as it is pumped, such that the fracturing fluid achieves the maximum second viscosity in the desired location in the borehole. The fracturing fluid reduces friction between components of the drilling and fracturing equipment during a hydrocarbon-bearing treatment operation. As the fracturing fluid travels downhole, the fracturing fluid can also carry proppant and other additives that may be added to the fracturing fluid downhole.

In another embodiment, the carrier fluid can be pumped into the hydrocarbon-bearing formation, i.e., downhole, and the synthetic polymer and optional additives can be introduced into the carrier fluid downhole. In this embodiment, rapid hydration of the viscosity-increasing synthetic polymer by the carrier fluid increases the viscosity of the fracturing fluid just before or as it is pumped, such that fracturing fluid achieves the maximum second viscosity in the desired location in the borehole. The fracturing fluid reduces friction between components of the drilling and fracturing equipment during a hydrocarbon-bearing treatment operation.

The fracturing fluid is generally formulated to reach its maximum second viscosity when it penetrates the fracture. Once in the fracture, any proppants present in the fracturing fluid are deposited in the fracture and used to prop open the fracture. When the fracture is supported by the proppant, or at any other desired stage, the self-breaking fracturing fluid breaks as times passes. The fracturing fluid can then be removed from the borehole. In some embodiments, removal of the fracturing fluid from the fracture leaves behind a conductive pathway supported by the deposited proppants. The conductive pathway permits extraction of hydrocarbons from the fracture.

At any suitable point in the process, the fracturing fluid can further be subjected to a breaking condition that increases the breaking of the fracturing fluid. As described above, the condition can be the passage of time or a temperature, pH, water content of the fracturing fluid, osmolality of the fracturing fluid, salt concentration of the fracturing fluid, additive concentration of the fracturing fluid (e.g., external oxidizing agents), presence of biological agents, or a combination comprising at least one of the foregoing conditions. Specifically, the change in condition facilitates degradation of the polymer, reducing viscosity of the fracturing fluid. The broken fracturing fluid can then be flowed back or removed from the borehole.

The fracturing fluid described herein has a number of advantages over commercially available fracturing fluids. The fracturing fluid primarily reduces friction between the carrier fluid and components of the fracturing equipment (primarily between the fluid and tubulars) during an early stage as well as during subsequent stages of dissolution of the polymer in the carrier fluid. It also prevents proppant from settling out of solution (phase separating) during subsequent stages of dissolution of the polymer in the carrier fluid. Since the viscosity-increasing polymer is synthetic, it is not subject to some of the production constraints associated with naturally occurring polymers. It is readily hydrated, and undergoes rapid dissolution when mixed with the carrier fluid. The ability of the polymer to rapidly dissolve into the carrier fluid minimizes the use of pre-dissolution procedures and hydration equipment, thus reducing capital costs and maintenance costs. This rapid dissolution ability also permits the carrier fluid to transport proppant downhole while remaining dissolved in the carrier fluid with reduced settling or falling out of solution during transport to the fracture. Its use significantly reduces formation damage, and undesirable coating of proppant materials or subterranean formation surfaces with the polymer or polymer residue. In some embodiments fracturing fluid can be formulated so that maximum viscosity and breaking of the fracturing fluid occur at specific times, for example after transporting the fluid deeply downhole. In some embodiments, increased temperature can be used to promote degradation of the fluid, and further lower the viscosity of the broken fluid.

The invention is further illustrated by the following non-limiting examples.

### EXAMPLES

### Example 1

This example was conducted to show the hydration and breaking of a self-breaking polymer at ambient temperature (about 68° F. (20° C.)). Polymer A is a synthetic polymer obtained from ChemEOR. Polymer B is a synthetic polymer, also obtained from ChemEOR. The carrier fluid is water.

Model fracturing fluids were prepared by mixing the polymer and water in a blender at ambient temperature. The fluid was prepared at a polymer concentration of 20 pounds per thousand gallons (pptg). A sample of each fluid was then placed in a viscometer and the sample was sheared by a rate sweep of 511 s⁻¹ for about 3.5 hours.

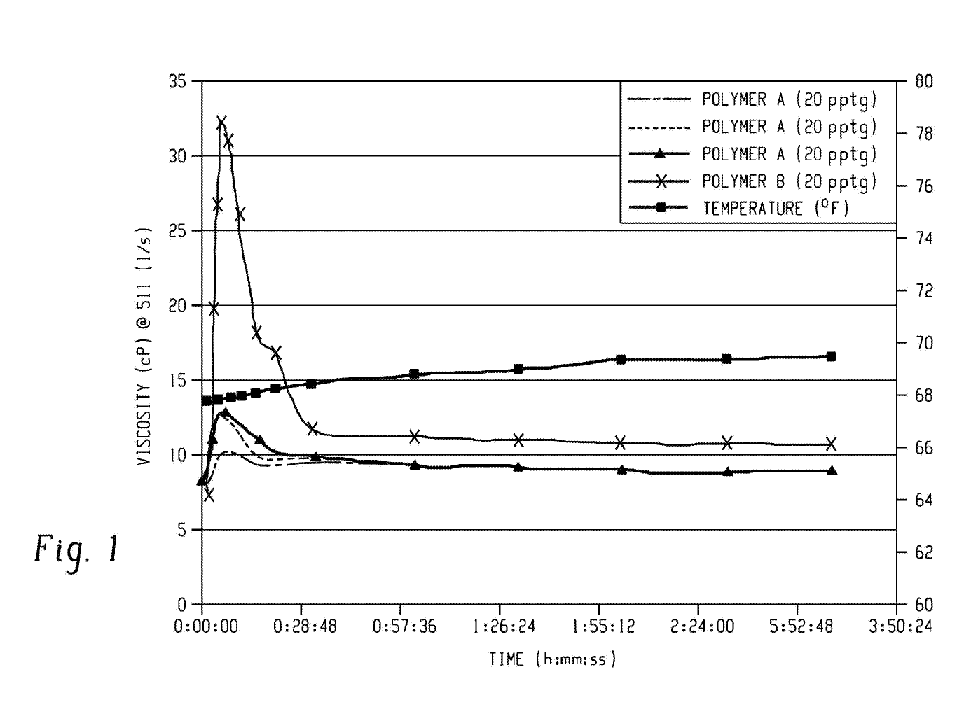

FIG. 1 shows the viscosity profile of the model fluids having a polymer concentration of 20 pptg. FIG. 1 shows that all model fracturing fluids increased in viscosity, and reached a maximum viscosity within about 20 minutes. The viscosity then decreased to about 8 to about 12 centipoise (cP). FIG. 1 further illustrates that the temperature remained essentially constant (±5° C.) throughout the course of the measurement. The change in viscosity that was observed is therefore not an effect of thermal thinning.

### Example 2

This example was conducted to show the hydration and breaking of the polymer at elevated temperature. The polymer is a synthetic polymer. The carrier fluid is water.

Model fracturing fluids were prepared by mixing the polymer and water in a blender at ambient temperature (about 68° F. (20° C.)). The fluid was prepared at a polymer concentration of 20 pptg. A sample of each fluid was then placed in a viscometer and sheared by a rate sweep of 511 s⁻¹ for about 3.5 hours.

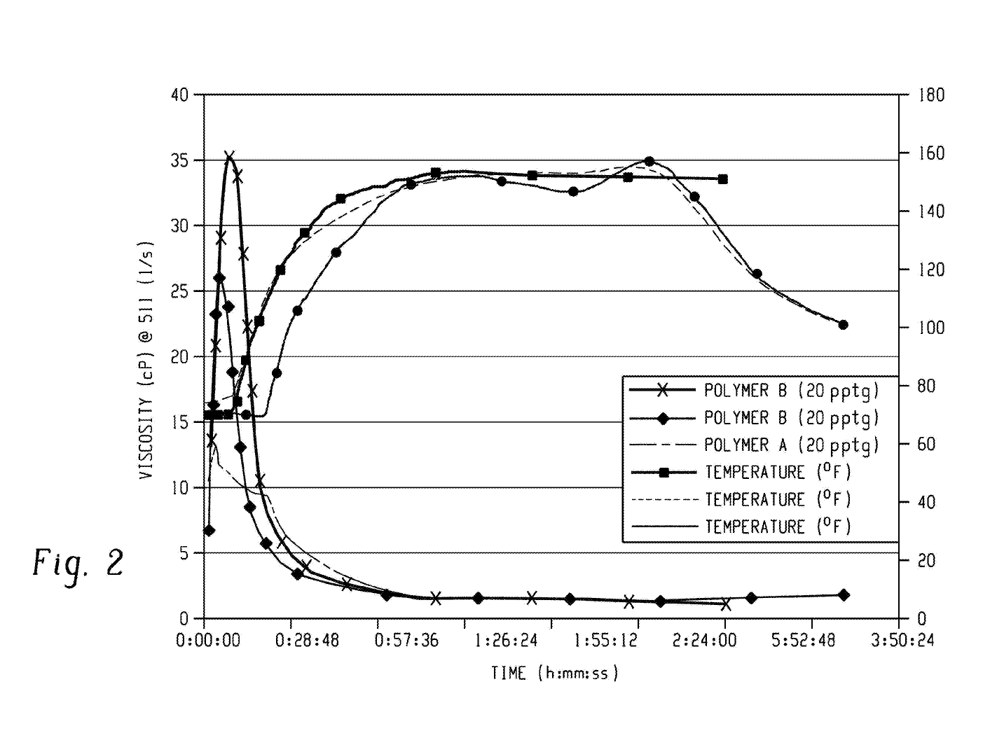

FIG. 2 shows the viscosity profile of each sample over time as the temperature was varied. Solutions were maintained at about 68° F. (20° C.) for about 15 minutes, then heated to about 150 to about 158° F. (about 60 to about 70° C.). Heating the fluids resulted in greater viscosity increases compared to maintaining the fluids at ambient temperature, as in Example 1. Furthermore, the model fracturing fluids ultimately had lower viscosities after breaking, indicating improved polymer degradation at elevated temperature. The final viscosities of the fluids were less than or equal to 3 cP.

Two of the model fracturing fluids were subsequently cooled to about 100 to about 120° F. (about 37 to about 48° C.). Cooling did not result in any change in fluid viscosity. Specifically, there was no recovery of the initial viscosity observed for the fluids. This example indicates that increased temperature promoted degradation of the polymer, and further that the effect of temperature on fluid viscosity was not simply a thermal thinning effect, as the viscosity of the fluid did not substantially increase upon cooling (FIG. 2). The third viscosity of the fluid remained lower than the initial viscosity of the fluid even when the temperature was reduced from about 150° F. to about 100° F.

The fracturing fluids and methods are further illustrated by the following embodiments, which are non-limiting:

Embodiment 1: A fracturing fluid for a subterranean formation, the fracturing fluid comprising: an aqueous carrier fluid; and a viscosity-increasing synthetic polymer soluble in the carrier fluid, wherein the polymer is self-breaking.

Embodiment 2: The fracturing fluid of embodiment 1, wherein the fracturing fluid has a first viscosity after a first period of time immediately subsequent to mixing of the polymer and the carrier fluid, a second viscosity after a second period of time subsequent to the first period, and a third viscosity after a third period of time subsequent to the second period, wherein the second viscosity is higher than the first viscosity and the third viscosity.

Embodiment 3: The fracturing fluid of embodiment 2, further wherein the third viscosity is lower than the first viscosity.

Embodiment 4: The fracturing fluid of any one or more of the preceding embodiments, wherein the fracturing fluid has a first viscosity of about 1 to about 60 centipoise at 20° C.

Embodiment 5: The fracturing fluid of any one or more of the preceding embodiments, wherein the maximum second viscosity at 20° C. is about 5 to about 60 centipoise at 20° C.

Embodiment 6: The fracturing fluid of any one or more of the preceding embodiments, wherein the third viscosity is about 1 to about 20 centipoise at 20° C.

Embodiment 7: The fracturing fluid of any one or more of the preceding embodiments, wherein a change in a condition of the fracturing fluid further decreases the third viscosity.

Embodiment 8: The fracturing fluid of embodiment 7, wherein the condition is temperature, pH, water content of the fracturing fluid, osmolality of the fracturing fluid, salt concentration of the fracturing fluid, additive concentration of the fracturing fluid, presence of biological agents, or a combination comprising at least one of the foregoing conditions.

Embodiment 9: The fracturing fluid of embodiment 7 or embodiment 8, wherein the third viscosity is less than 10 centipoise, preferably less than 5 centipoise, more preferably less than 3 centipoise.

Embodiment 10: The fracturing fluid of any one or more of the preceding embodiments, wherein the carrier fluid is present in an amount of about 90 to about 99.99 wt %, and the synthetic polymer is present in an amount of about 0.01 wt % to about 10 wt %, based on the combined weight of the carrier fluid and the synthetic polymer.

Embodiment 11: The fracturing fluid of any one or more of the preceding embodiments, wherein the synthetic polymer comprises a backbone comprising repeating units derived from (meth)acrylamide, N—(C₁-C₈ alkyl)acrylamide N,N-di(C₁-C₈ alkyl)acrylamide, vinyl alcohol, allyl alcohol, vinyl acetate, acrylonitrile, (meth)acrylic acid, ethacrylic acid, α-chloroacrylic acid, β-cyanoacrylic acid, β-methylacrylic acid (crotonic acid), α-phenylacrylic acid, β-acryloyloxypropionic acid, maleic acid, maleic anhydride, fumaric acid, itaconic acid, sorbic acid, α-chlorosorbic acid, 2′-methylisocrotonic acid, 2-acrylamido-2-methylpropane sulphonic acid, allyl sulphonic acid, vinyl sulphonic acid, allyl phosphonic acid, vinyl phosphonic acid, (C₁₋₆ alkyl) (meth)acrylate, (hydroxy-C₁₋₆ alkyl) (meth)acrylate, (dihydroxy-C₁₋₆ alkyl) (meth)acrylate, (trihydroxy-C₁₋₆ alkyl) (meth)acrylate, diallyl dimethyl ammonium chloride, di-(C₁₋₆ alkyl)amino (C₁₋₆ alkyl) (meth)acrylate, 2-ethyl-2-oxazoline, (meth)acryloxy(C₁₋₆ alkyl) tri(C₁₋₆ alkyl)ammonium halide), 2-vinyl-1-methylpyridinium halide), 2-vinylpyridine N-oxide), 2-vinylpyridine, or a combination comprising at least one of the foregoing.

Embodiment 12: The fracturing fluid of embodiment 11, wherein the synthetic polymer comprises a backbone comprising repeating units derived from (meth)acrylamide.

Embodiment 13: The fracturing fluid of embodiments 11 or 12, wherein the synthetic polymer comprises labile groups that comprises ester groups, amide groups, carbonate groups, azo groups, disulfide groups, orthoester groups, acetal groups, etherester groups, ether groups, silyl groups, phosphazine groups, urethane groups, esteramide groups, etheramide groups, anhydride groups, or a combination comprising at least one of the foregoing groups.

Embodiment 14: The fracturing fluid of any one or more of the preceding embodiments, further comprising a proppant.

Embodiment 15: The fracturing fluid of any one or more of the preceding embodiments, further comprising a breaking agent, preferably an oxidizing agent.

Embodiment 16: The fracturing fluid of any one or more of the preceding embodiments, further comprising an additive, wherein the additive is a pH agent, a buffer, a mineral, an oil, an alcohol, a biocide, a clay stabilizer, a surfactant, viscosity modifier different from the viscosity-increasing agent, an emulsifier, a non-emulsifiers, a scale-inhibitors, a fiber, a fluid loss control agent, or a combination comprising at least one of the foregoing.

Embodiment 17: The fracturing fluid of any one or more of the preceding embodiments, wherein the fracturing fluid is devoid of a breaking agent.

Embodiment 18: The fracturing fluid of any one or more of the preceding embodiments, wherein the viscosity-increasing polymer is a crosslinked polymer.

Embodiment 19: A method for treating a hydrocarbon-bearing formation, the method comprising introducing the fracturing fluid of any one or more of embodiments 1-18 into a borehole in the hydrocarbon-bearing formation; maintaining the fracturing fluid in the borehole for a period of time effective for self-breaking of the fracturing fluid; and recovering the broken fracturing fluid.

Embodiment 20: The method of embodiment 19, wherein the introducing is during a stimulation treatment, a fracturing treatment, an acidizing treatment, a friction-reducing treatment, or a downhole completion operation.

Embodiment 21: The method of any one or more of embodiments 19 to 20, further comprising subjecting the fracturing fluid to a breaking condition.

All ranges disclosed herein are inclusive of the endpoints, and the endpoints are independently combinable with each other. “Combination” is inclusive of blends, mixtures, alloys, reaction products, and the like. The term “(meth)acryl” is inclusive of both acryl and methacryl. Furthermore, the terms “first,” “second,” and the like do not denote any order, quantity, or importance, but rather are used to denote one element from another. The terms “a” and “an” and “the” as used herein do not denote a limitation of quantity, and are to be construed to cover both the singular and the plural, unless otherwise indicated herein or clearly contradicted by context. “Or” means “and/or” unless otherwise indicated herein or clearly contradicted by context. In general, the invention can alternatively comprise, consist of, or consist essentially of, any appropriate components herein disclosed. The invention can additionally, or alternatively, be formulated so as to be devoid, or substantially free, of any components, materials, ingredients, adjuvants or species used in the prior art compositions or that are otherwise not necessary to the achievement of the function and/or objectives of the present invention. Embodiments herein can be used independently or can be combined.

All references are incorporated herein by reference.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A fracturing fluid for a subterranean formation, the fracturing fluid comprising:
an aqueous carrier fluid; and
a viscosity-increasing synthetic polymer soluble in the carrier fluid, wherein the polymer is self-breaking.

2. The fracturing fluid of claim 1, wherein the fracturing fluid has
a first viscosity after a first period of time immediately subsequent to mixing of the polymer and the carrier fluid,
a second viscosity after a second period of time subsequent to the first period, and
a third viscosity after a third period of time subsequent to the second period, wherein the second viscosity is higher than the first viscosity and the third viscosity.

3. The fracturing fluid of claim 2, further wherein the third viscosity is lower than the first viscosity.

4. The fracturing fluid of claim 2, wherein the fracturing fluid has a first viscosity of about 1 to about 60 centipoise at 20° C.

5. The fracturing fluid of claim 2, wherein the maximum second viscosity at 20° C. is about 5 to about 60 centipoise at 20° C.

6. The fracturing fluid of claim 2, wherein the third viscosity is about 1 to about 20 centipoise at 20° C.

7. The fracturing fluid of claim 1, wherein a change in a condition of the fracturing fluid further decreases the third viscosity, wherein the condition is temperature, pH, water content of the fracturing fluid, osmolality of the fracturing fluid, salt concentration of the fracturing fluid, additive concentration of the fracturing fluid, presence of biological agents, or a combination comprising at least one of the foregoing conditions.

8. The fracturing fluid of claim 7, wherein the third viscosity is less than 10 centipoise, preferably less than 5 centipoise, more preferably less than 3 centipoise.

9. The fracturing fluid of claim 1, wherein the carrier fluid is present in an amount of about 90 to about 99.99 wt %, and the synthetic polymer is present in an amount of about 0.01 wt % to about 10 wt %, based on the combined weight of the carrier fluid and the synthetic polymer.

10. The fracturing fluid of claim 1, wherein the synthetic polymer comprises a backbone comprising repeating units derived from (meth)acrylamide, N—(C₁-C₈ alkyl)acrylamide N,N-di(C₁-C₈ alkyl)acrylamide, vinyl alcohol, allyl alcohol, vinyl acetate, acrylonitrile, (meth)acrylic acid, ethacrylic acid, α-chloroacrylic acid, β-cyanoacrylic acid, β-methylacrylic acid (crotonic acid), α-phenylacrylic acid, β-acryloyloxypropionic acid, maleic acid, maleic anhydride, fumaric acid, itaconic acid, sorbic acid, α-chlorosorbic acid, 2′-methylisocrotonic acid, 2-acrylamido-2-methylpropane sulphonic acid, allyl sulphonic acid, vinyl sulphonic acid, allyl phosphonic acid, vinyl phosphonic acid, (C₁₋₆ alkyl) (meth)acrylate, (hydroxy-C₁₋₆ alkyl) (meth)acrylate, (dihydroxy-C₁₋₆ alkyl) (meth)acrylate, (trihydroxy-C₁₋₆ alkyl) (meth)acrylate, diallyl dimethyl ammonium chloride, di-(C₁₋₆ alkyl)amino (C₁₋₆ alkyl) (meth)acrylate, 2-ethyl-2-oxazoline, (meth)acryloxy(C₁₋₆ alkyl) tri(C₁₋₆ alkyl)ammonium halide), 2-vinyl-1-methylpyridinium halide), 2-vinylpyridine N-oxide), 2-vinylpyridine, or a combination comprising at least one of the foregoing.

11. The fracturing fluid of claim 10, wherein the synthetic polymer comprises a backbone comprising repeating units derived from (meth)acrylamide.

12. The fracturing fluid of claim 1, wherein the synthetic polymer comprises labile groups that comprises ester groups, amide groups, carbonate groups, azo groups, disulfide groups, orthoester groups, acetal groups, etherester groups, ether groups, silyl groups, phosphazine groups, urethane groups, esteramide groups, etheramide groups, anhydride groups, or a combination comprising at least one of the foregoing groups.

13. The fracturing fluid of claim 1, further comprising a proppant.

14. The fracturing fluid of claim 1, further comprising a breaking agent, preferably an oxidizing agent.

15. The fracturing fluid of claim 1, further comprising an additive, wherein the additive is a pH agent, a buffer, a mineral, an oil, an alcohol, a biocide, a clay stabilizer, a surfactant, viscosity modifier different from the viscosity-increasing agent, an emulsifier, a non-emulsifiers, a scale-inhibitors, a fiber, a fluid loss control agent, or a combination comprising at least one of the foregoing.

16. The fracturing fluid of claim 1, wherein the fracturing fluid is devoid of a breaking agent.

17. The fracturing fluid of claim 1, wherein the viscosity-increasing polymer is a crosslinked polymer.

18. A method for treating a hydrocarbon-bearing formation, the method comprising
introducing the fracturing fluid of claim 1 into a borehole in the hydrocarbon-bearing formation;
maintaining the fracturing fluid in the borehole for a period of time effective for self-breaking of the fracturing fluid; and
recovering the broken fracturing fluid.

19. The method of claim 18, wherein the introducing is during a stimulation treatment, a fracturing treatment, an acidizing treatment, a friction-reducing treatment, or a downhole completion operation.

20. The method of claim 18, further comprising subjecting the fracturing fluid to a breaking condition.
